(19) United States
(12) Patent Application Publication
(10) Pub. No.: US 2025/0362709 A1
(43) Pub. Date: Nov. 27, 2025

(54) PORTABLE INFORMATION HANDLING SYSTEM HINGE-UP DISPLAY RETENTION FOR AUTOMATED ASSEMBLY

(71) Applicant: Dell Products L.P., Round Rock, TX (US)

(72) Inventors: Allen B. McKittrick, Cedar Park, TX (US); Paul R. Lalinde, Spring, TX (US); Jeffrey D. Kane, Austin, TX (US)

(73) Assignee: Dell Products L.P., Round Rock, TX (US)

(21) Appl. No.: 18/669,978

(22) Filed: May 21, 2024

(51) Int. Cl. G06F 1/16

(52) U.S. Cl. CPC G06F 1/1637; G06F 1/1616

(57) ABSTRACT

A portable information handling system display assembly couples to a portable housing with spring clips that extend out from a support of the display assembly to engage against the portable housing, such as within cavities formed in the housing to align the display assembly with a desired position. In one embodiment, the spring clips extend out from the support and up towards a display panel to compress against a side of the support. In an alternative embodiment, the spring clips extend out from the support and down away from the display panel.

### BACKGROUND OF THE INVENTION

### Field of the Invention

The present invention relates in general to the field of portable information handling systems, and more particularly to a portable information handling system hinge-up display retention for automated assembly.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In a clamshell configuration, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility.

Generally, end users prefer to have low profile portable systems that have minimal weight and thickness to enhance portability. One factor that drives portable information handling system housing size is the size of the display included in the portable housing. In addition to the size of the viewing area, which is typically an end user selection, the display panel tends to drive housing thickness in that the display panel has to have enough support to avoid warpage during use, such as due to forces applied when the housing is rotated open and closed. One way to provide display panel support is to secure the display panel to the housing with screws around the display panel perimeter. However, fastening with screws tends to result in a border area around the display panel that leaves a gap that is typically covered with a bezel. The bezel increases the size of the housing perimeter to couple a display panel of a given size and tends to detract from the aesthetic appearance of the display. In contrast, a “zero bezel” design has the display panel extend to the sides of the housing with minimal or no bezel around the perimeter. To avoid the use of a bezel, the display panel is instead bonded in place with adhesive or adhesive tape. Using adhesive typically means that the display panel is not serviceable after installation. Without screws or adhesive, the display panel generally will not couple with sufficient strength to withstand shock and vibration requirements. Further, screws and adhesives tend to disrupt automated manufacturing processes as too difficult for robotic manipulation.

### SUMMARY OF THE INVENTION

Therefore, a need has arisen for a system and method which simplifies assembly of a display in an information handling system housing in a robust manner.

In accordance with the present invention, a system and method are provided which substantially reduce the disadvantages and problems associated with previous methods and systems for coupling a display into an information handling system housing. Spring clips extending out from opposing side surfaces of a display assembly engage against housing side walls to hold the display assembly in place in the housing.

More specifically, a portable information handling system processes information with processing components coupled in a portable housing, such as a processor that executes instructions to process information and a memory interfaced with the processor stores the instructions and information. The portable housing has a lid portion with cavities formed in opposing side walls to accept display assembly spring clips. The display assembly has a support with spring clips extending out from a bottom surface to engage the housing side walls and couple into the cavities. In one example embodiment, the spring clips extend up towards a display panel and bend back towards the display support so that a curved portion pressing against the housing side wall generates spring tension resisted by the spring clip end against the display support side wall. In an alternative embodiment, the spring clips extend down away from the display panel to press against the housing side wall. In one embodiment, the display assembly slides into the housing to fit an extension under a lip that holds the display assembly in place.

The present invention provides a number of important technical advantages. One example of an important technical advantage is that a display assembly couples into place in a housing with spring clips extending out from a lower side of the display assembly support and bias against the housing side wall. Once the display assembly couples in place, minimal additional securing is used to hold the assembly together so that disassembly for recycling is less complex and expensive. The opposing tension provided by the spring clips against the housing side surface offers a robust solution against shock and vibration to hold the information handling system display in place.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system that couples a display assembly to a housing lid portion with spring clips;

FIGS. 2A and 2B depict an upper perspective view of the coupling of the display assembly to the housing lid portion with tension by spring clips;

FIGS. 3A and 3B depict an upper side perspective and sectional view of the display assembly of one embodiment of spring clips that engage against the housing lid portion;

FIGS. 4A and 4B depict an upper side perspective and sectional view of an alternative embodiment of spring clips to couple the display assembly to the housing lid portion;

FIGS. 5A and 5B depict side and sectional views of an example of assembly of the display assembly into the housing lid portion;

FIGS. 6A-D depict a flow diagram of a process for assembly of a display assembly into a housing lid portion;

FIGS. 7A and 7B depict alternative examples of spring clips that couple the display assembly to the housing; and

FIGS. 8A and 8B depict alternative examples of assembly of the display assembly into the housing lid portions.

### DETAILED DESCRIPTION

Spring clips extend out from a display assembly to couple the display assembly to a portable information handling system housing by resilient tension of the spring clips working against the housing. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

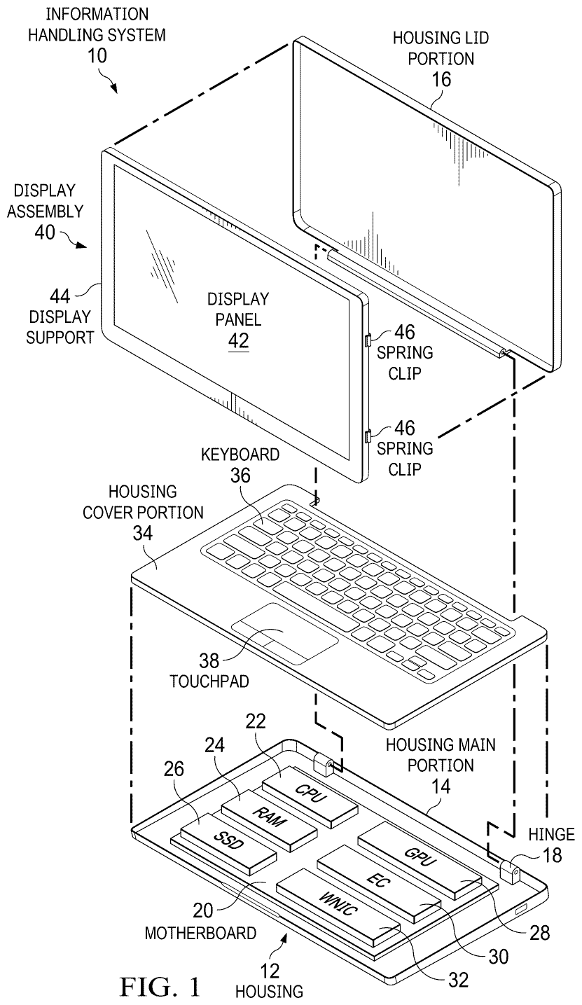

Referring now to FIG. 1, an information handling system is depicted that couples a display assembly to a housing lid portion with spring clips. Information handling system 10 is built in a portable housing 12 having a main portion 14 rotationally coupled to a lid portion 16 by a hinge 18. A motherboard 20 couples in housing main portion 14 to support communication between processing components that cooperate to process information. For example, a central processing unit (CPU) 22 executes instructions to process information in cooperation with a random access memory (RAM) 24 that stores the instructions and information. A solid state drive (SSD) 26 provides persistent storage of information and instructions during system power down, such as an operating system and applications that are retrieved to RAM for execution during system operation. A graphics processing unit (GPU) 28 interfaces with CPU 22 to further process the information and generate visual images, such as with pixel values that define the visual image as composite of an array of pixels of a display panel. An embedded controller (EC) 30 manages physical operating conditions at the system, such as power and thermal conditions, and manages interactions with input/output (I/O) devices. A wireless network interface controller (WNIC) 32 supports network communications, such as through Ethernet, WIFI and BLUETOOTH. The example embodiment has a convertible configuration with a housing cover portion 34 coupled to main portion 14 over the processing components and supporting a keyboard 36 and touchpad 38 that accept end user inputs.

Information handling system 10 presents information as visual images at a display panel 42 coupled in housing lid portion 16, such as a liquid crystal display (LCD) panel or an organic light emitting diode (OLED) display film. The display panel 42 is included in a display assembly that couples as a unit in lid portion 16. Display assembly 40 includes a display support 44 that holds display panel 42 and has spring clips 46 extending out from opposing sides of display support 44. Spring clips 46 engage against side surfaces of housing lid portion 16 with spring tension that holds display assembly 40 in place in housing lid portion 16. Spring clips 46 are positioned to align with cavities formed in the sides of housing lid portion 16 to hold the display panel in a desired position and then the display assembly is locked into place, such as with a screw or adhesive, as is described in greater depth below.

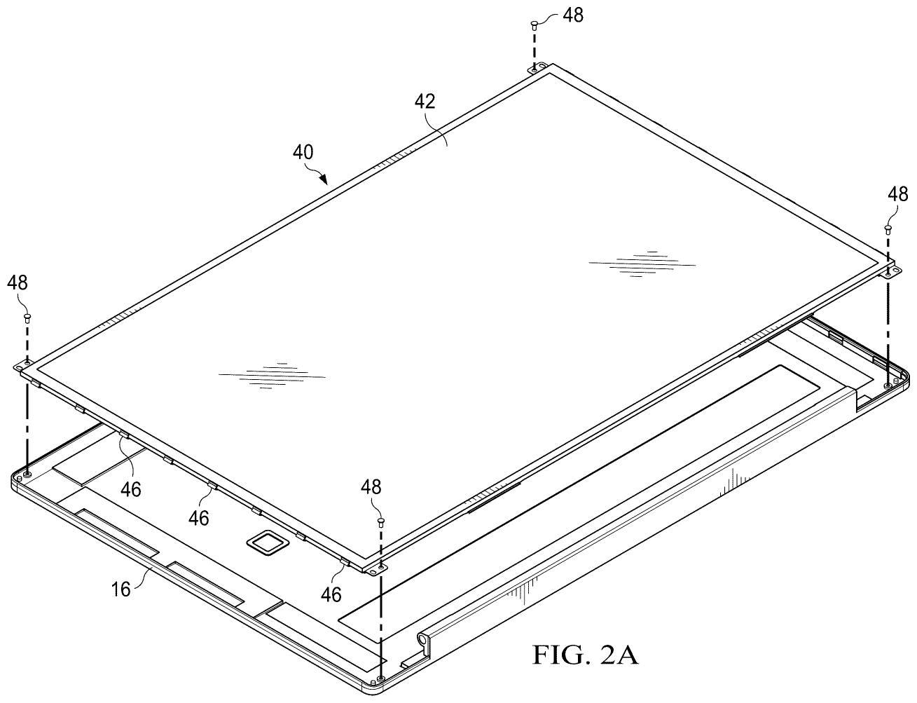

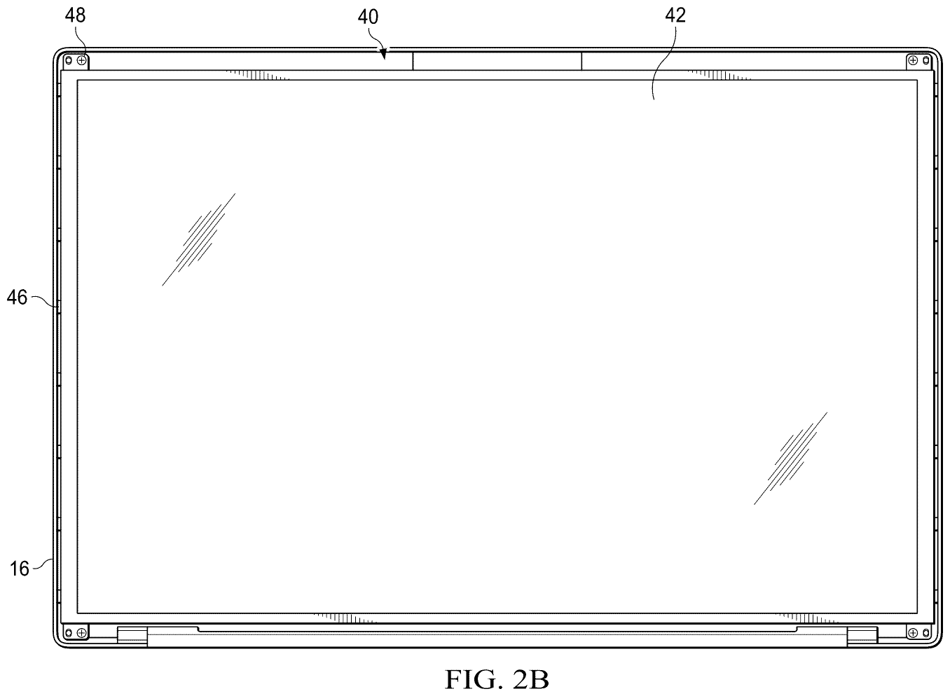

Referring now to FIGS. 2A and 2B, an upper perspective view depicts coupling of display assembly 40 to housing lid portion 16 with tension by spring clips 46. In the example embodiment, display assembly 40 is held centered over housing lid portion 16 and pressed down so that spring clips 46 one each of the opposing vertical sides display assembly 40 engage against a side raised surface of lid portion 16. Screws 48 align with a screw hole on each corner of lid portion 16 to secure display assembly in place once spring clips 46 operate to position display panel 42 by opposing spring tension. The vertical side surfaces of display panel 42 have a minimal spacing to the raised sides of housing lid portion 16, such 0.1 mm. Display assembly 40 engages with a positive click or similar feedback when spring clips 46 fit into cavities formed to provide display panel alignment.

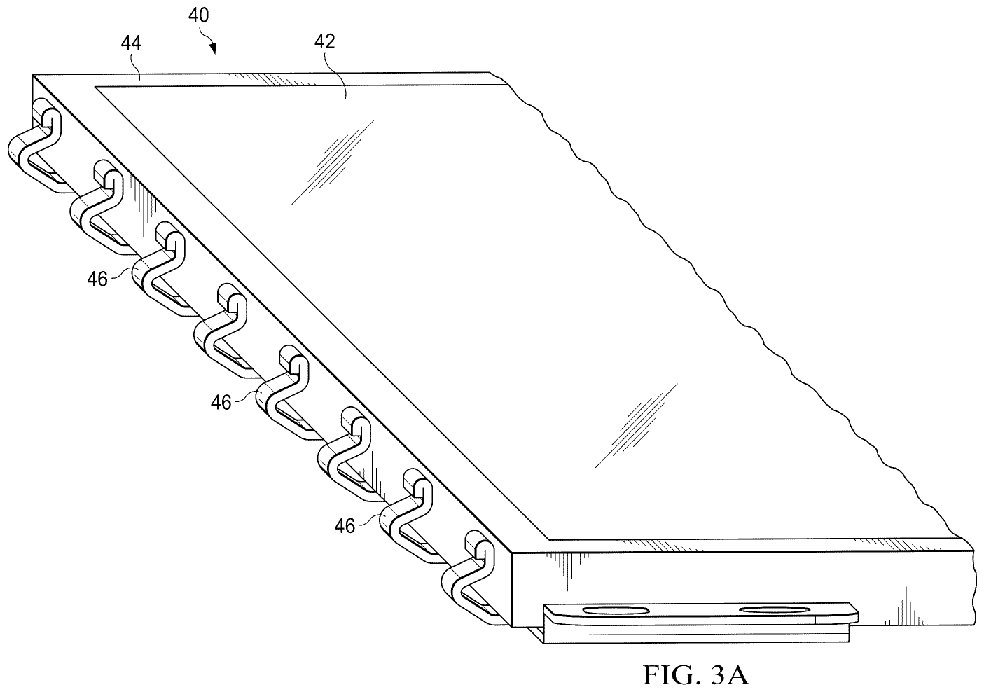

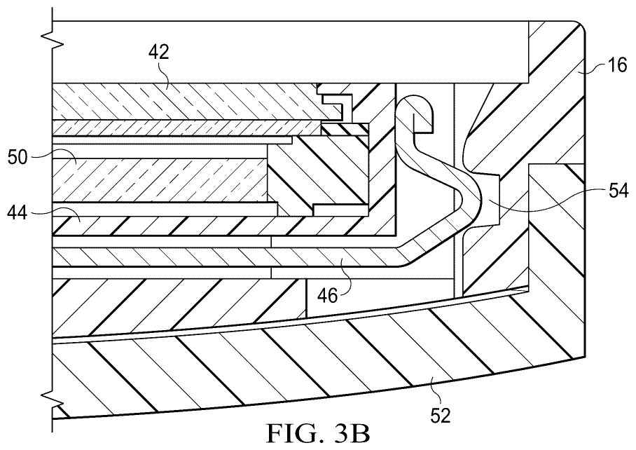

Referring now to FIGS. 3A and 3B, an upper side perspective and sectional view of the display assembly 40 depicts one embodiment of spring clips 46 that engage against the housing lid portion 16. In the example embodiment, spring clips 46 couple to a bottom side of support 44 with an upward curve towards display panel 42 with the curved portion pressing into a cavity 54 formed in housing lid portion 16 and an end bending back against support 44. The result of the upward and outward bend is to generate tension at the bent portion of spring clip 46 pressing against housing lid portion 16 on one side and against support 44 at the end of spring clip 46. In the example embodiment, display assembly 40 couples an LCD display panel 42 over a backlight 50 within support 44 so that the assembly fits into housing lid portion 16 having spring clips 46 aligned with cavities 54 to engage and hold the display assembly aligned in place. An outer cover 52 couples to the outer surface of housing lid portion 16 and a glass outer surface couples over display panel 42 to cover the zero edge gap between the side surfaces of support 44 and housing lid portion 16. Spring clips 46 are a resilient material to generate spring tension that can be spot welded, adhered or directly formed into and integrated with the material of support 44. For instance, spring clips 46 are cut sheet metal strips integral with support 44 that are then bent to the desired form. In one embodiment, support 44 and spring clips 46 are conductive material that establishes ground from the display assembly to the housing to aid in display performance and management of electrostatic discharge. Although any resilient material will provide spring tension for holding the display assembly in place, stainless steel and nickel titanium alloy are two examples of materials that maintain resilience over time. The engagement of spring clips 46 between support 44 and housing lid portion 16 help to control flatness tolerance and prevent the sides from flexing during shock and vibration.

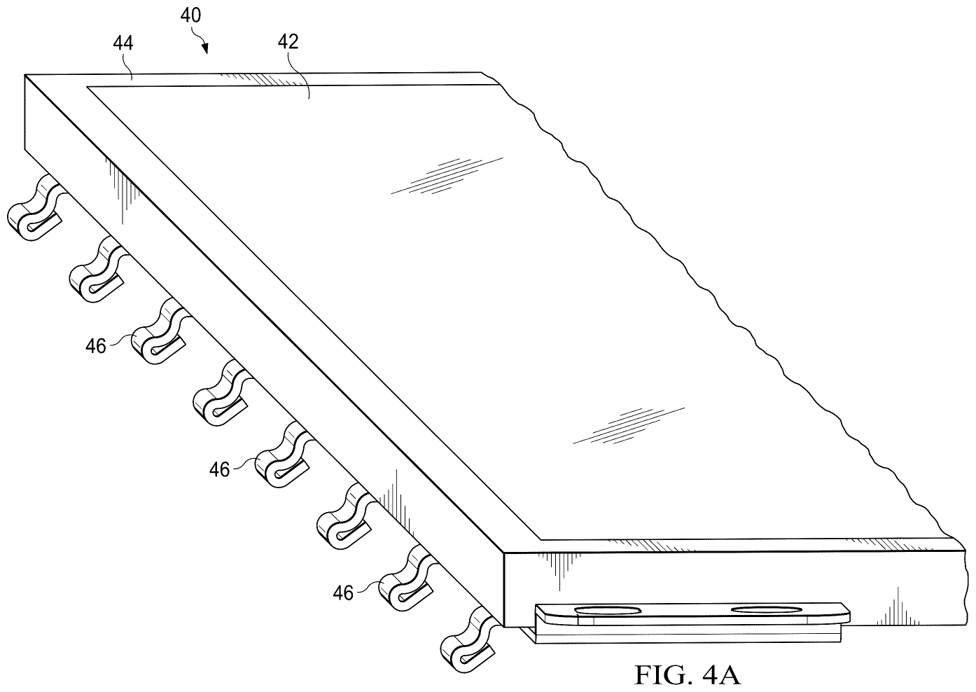

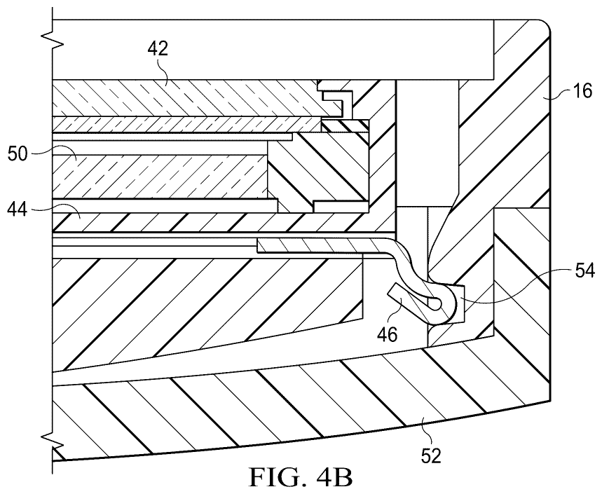

Referring now to FIGS. 4A and 4B, an upper side perspective and sectional view depict an alternative embodiment of spring clips to couple the display assembly to the housing lid portion. In the example embodiment, spring clips 46 couple to the bottom side of support 44 and extend out and downward away from display panel 42 to engage cavity 54 with a curved portion. The downward orientation of spring clip 46 generates tension that operates to bias the display assembly into the interior of housing lid portion 16.

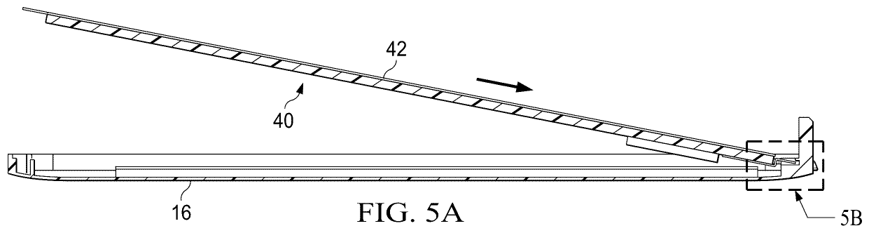

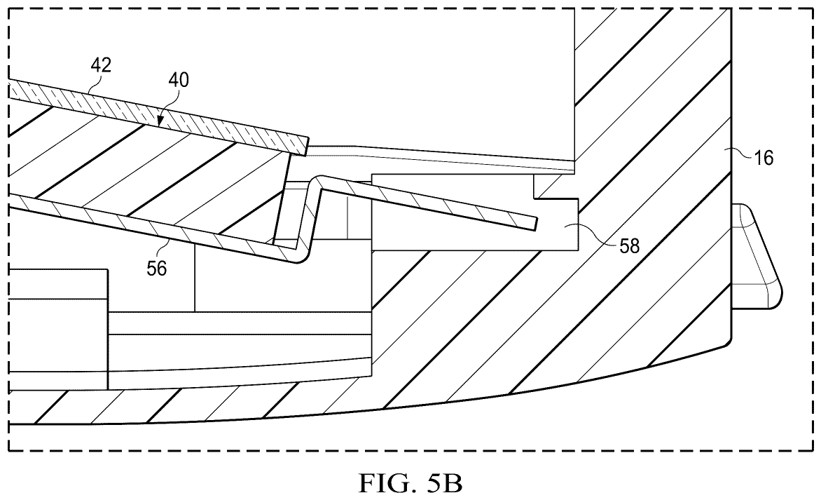

Referring now to FIGS. 5A and 5B, side and sectional views depict an example of assembly of the display assembly into the housing lid portion. Display assembly 40 with display panel 42 slides from a lower side of housing lid portion 16 to place an extension 56 of the display assembly under a lip 58 formed in the housing lid portion. Once the extension fits under the lip, a press down on display assembly 40 engages spring clips extend out both opposing side surfaces of the display support against raised side surface of the housing lid portion to hold the display assembly in place in the housing lid portion. At completion of the engagement of the spring clips, the display assembly may be secured in place with screws coupled to the bottom side of the display near the housing hinges. Alternatively, adhesive or adhesive tape may be used to hold the display assembly in place once it is firmly pressed into place.

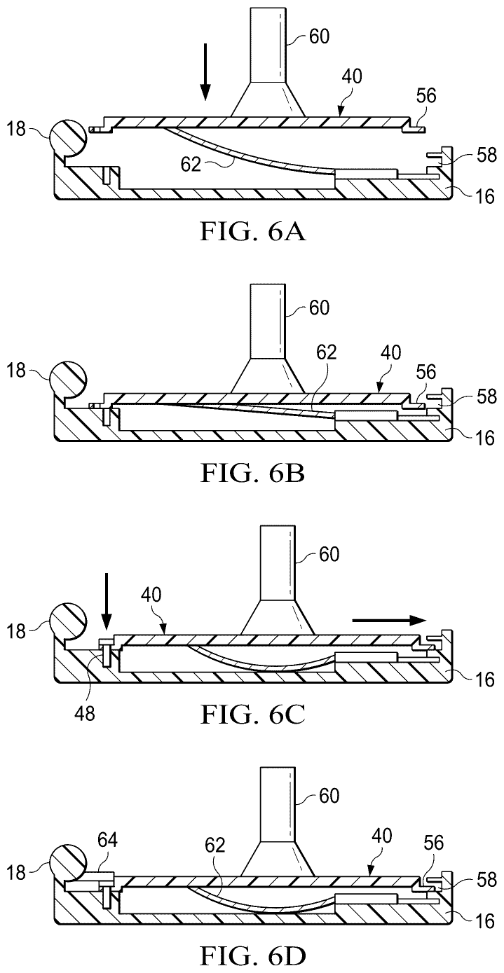

Referring now to FIGS. 6A-D, a flow diagram depicts a process for assembly of a display assembly into a housing lid portion. A suction fixture 60 couples to the display assembly 40 to hold the display assembly over the housing lid portion 16 for coupling of the display flexible cable 62 to a socket. Extension 56 is then aligned to insert into lip 58 with display assembly 40 lowered at a top side and slid into position. Upon engagement of extension 56 under lip 58, a press down by suction fixture 60 engages the spring clips to hold the display assembly in place while a screw fixes the display assembly to the housing lid portion. Finally, a bezel 64 fits over the bottom side of the display assembly near the hinges 18 to cover the mechanics of the assembly. Tape or adhesive may also be used to hold the display assembly in place. In the example embodiments, the spring clips are disposed only on first and second vertical sides of the display assembly to generate opposing tensions that center the display assembly in the housing and hold the display assembly in place. In an alternative embodiment, all four sides may include the spring clips to hold the display assembly in place with screws or adhesive to secure the display assembly in a fixed manner.

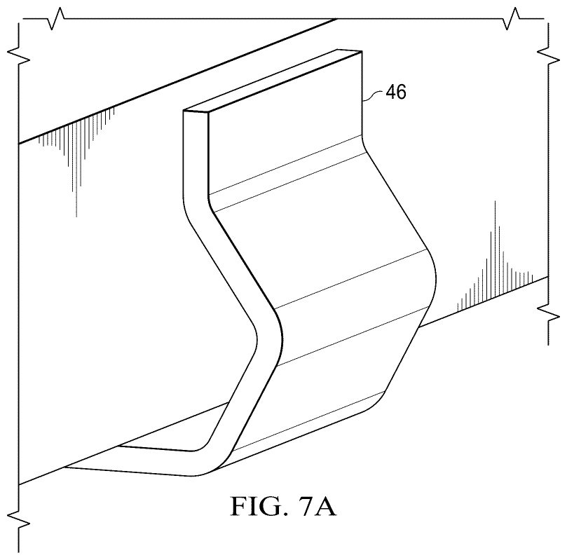

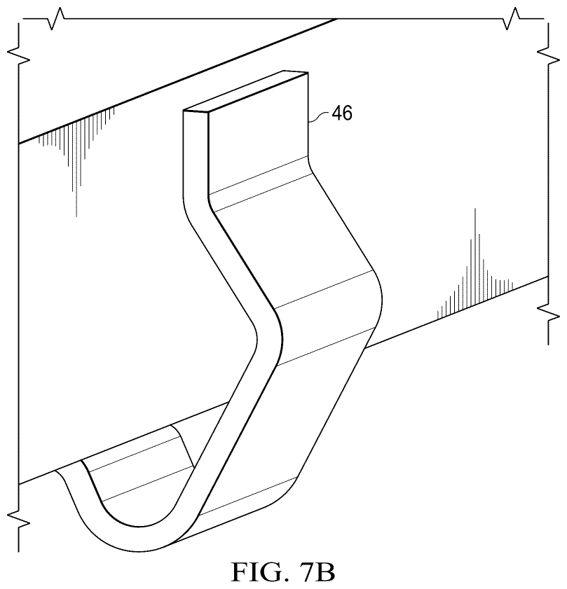

Referring now to FIGS. 7A and 7B, alternative examples of spring clips 46 that couple the display assembly to the housing are depicted. FIG. 7A depicts an example spring clip 46 that bends to extend away from the display assembly support and terminates at a flat portion that works against the support side surface to generate tension when the curved portion is pressed towards the support side wall. FIG. 7B depicts an example spring clip 46 that has a bottom bend portion extending below the lower surface of the support to create tension when the display assembly is pressed downward into position against the housing. The lower bend portion of spring clip 46 provides vertical adjustment space for the display assembly to slide and fit under the housing lip as described above with respect to FIGS. 5 through 6.

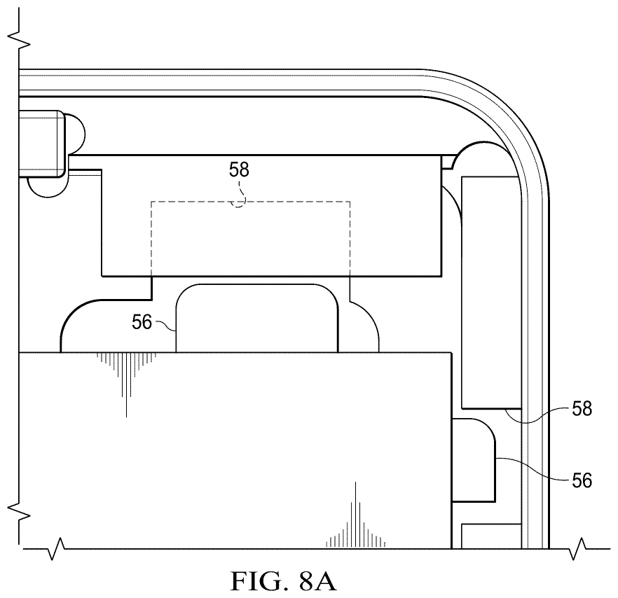

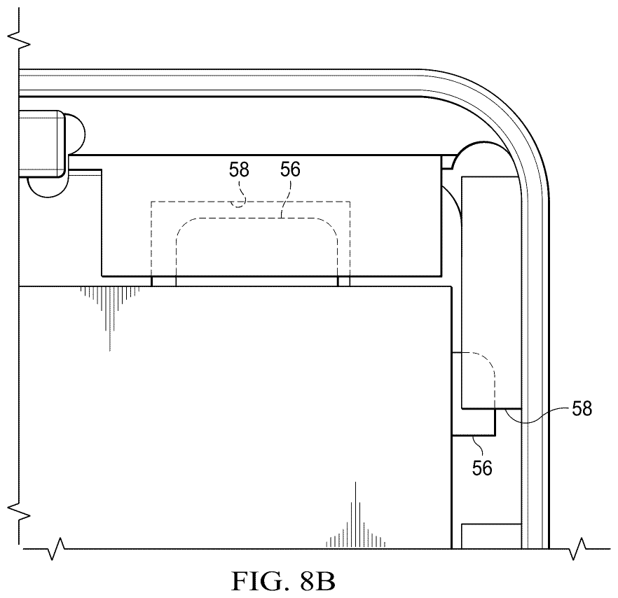

Referring now to FIGS. 8A and 8B, alternative examples are depicted of assembly of the display assembly into the housing lid portion. In the example embodiment, extensions 56 proceed out from the top and side of the display assembly support to engage under lips 58 of the housing lid portion and hold the display assembly in place. The extensions and lips of the top and side are normal in orientation relative to each other so that a sliding motion of the display assembly up from the hinge side of the housing towards the top side of the housing engages both the side extension into the side lip and the top extension into the top lip.

Although the present invention has been described in detail, it should be understood that various changes, substitutions and alterations can be made hereto without departing from the spirit and scope of the invention as defined by the appended claims.

What is claimed is:

1. An information handling system comprising:
a housing having a main portion and a lid portion;
a processor coupled in the main portion and operable to execute instructions to process information;
a memory coupled in the main portion and interfaced with the processor, the memory operable to store the instructions and information; and
a display assembly coupled in the lid portion, the display assembly having a display panel coupled to a support, the support having plural spring clips extending from opposing sides and engaging against the lid portion, each of the plural spring clips having tension pressing against the lid portion to couple the support in place.

2. The information handling system of claim 1 wherein the spring clips further couple at a bottom side of the display assembly and extend up towards the display panel.

3. The information handling system of claim 1 wherein the spring clips further couple at a bottom side of the display assembly and extend down and away from the display panel.

4. The information handling system of claim 1 further comprising:
a lip formed in the lid portion at a side normal the opposing sides having the spring clips; and
an extension from the display assembly aligned to slide under the lip.

5. The information handling system of claim 4 further comprising a screw coupling the display assembly to the lid portion at a side opposite the lip when the extension slides under the lip.

6. The information handling system of claim 1 wherein the plural spring clips each comprise a strip of sheet metal bent to form a curved portion aligned to press against the lid portion.

7. The information handling system of claim 6 wherein the lid portion has a cavity formed to align with each of the plural spring clips.

8. The information handling system of claim 7 wherein the display assembly support has a metal material and the strip of sheet metal is cut from the metal material to integrate with the display assembly support.

9. The information handling system of claim 7 wherein the plural spring clips comprise stainless steel coupled to the display assembly support.

10. A method for coupling a display assembly into an information handling system housing, the method comprising:
extending plural spring clips out of opposing sides of the display assembly;
pressing the display assembly into the housing to engage the plural spring clips against the housing to have the spring clip tension hold the display assembly in the housing.

11. The method of claim 10 further comprising:
forming plural cavities in the housing, each of the plural cavities aligned with one of the plural spring clips; and
engaging the plural spring clips in the plural cavities to hold the display assembly in the housing.

12. The method of claim 11 further comprising forming the spring clips to extend out from a support of the display assembly and up towards a display panel of the display assembly.

13. The method of claim 11 further comprising forming the spring clips to extend out from a support of the display assembly and downward away from a display panel of the display assembly.

14. The method of claim 13 further comprising:
cutting the strips out of the support to remain integral with the support; and
bending the strips to form the spring clips.

15. The method of claim 11 further comprising:
sliding an extension of the display assembly normal the opposing sides of the display assembly to engage under a lip of the housing; and
aligning the plural spring clips and the plural cavities by the sliding before pressing the display assembly into the housing.

16. The method of claim 15 further comprising securing the display assembly to the housing with a screw at a side opposite the extension.

17. A display assembly comprising:
a display panel operable to present information as visual images;
a backlight coupled under the display panel and operable to illuminate the visual images;
a support coupled under the backlight; and
spring clips extending out from opposing sides of the support and configured to engage against a housing holding the support.

18. The display assembly of claim 17 wherein the spring clips extend out from a lower side of the support to curve out from the support and up towards the display panel, the spring clips bending towards the support when engaged against the housing to have an end of the spring clip working against the support and resiliently holding the curve against pressure of the housing.

19. The display assembly of claim 17 wherein the spring clips extend out from a lower side of the support to curve out from the support and down away from the display panel.

20. The display assembly of claim 19 further comprising a housing having a cavities aligned to accept the spring clips when the support aligns in the housing.
